(19) United States
(12) Patent Application Publication
(10) Pub. No.: US 2025/0154816 A1
(43) Pub. Date: May 15, 2025

(54) CURSOR FOR FRAMELESS GLASS IN A VEHICLE

(71) Applicants: Inteva Products, LLC, Troy, MI (US); INTEVA PRODUCTS ZHENJIANG CO., LTD, Zhenjiang (CN)

(72) Inventors: Qiangxi Fu, Zhenjiang (CN); Jiang Feng, Jiading (CN); Yifan Fan, Zhenjiang (CN); Zhengliang Deng, Zhenjiang (CN)

(21) Appl. No.: 18/941,868

(22) Filed: Nov. 8, 2024

(30) Foreign Application Priority Data
Nov. 10, 2023 (CN) 202311497872.9
Nov. 10, 2023 (CN) 202323050862.9

(51) Int. Cl. E05F 15/689; B60J 1/17

(52) U.S. Cl. CPC E05F 15/689; B60J 1/17

(57) ABSTRACT

An adjustable cursor assembly (10) for a frameless window (28) of a vehicle door, including: a cursor body (16), the cursor body having a hook portion (40), the hook portion (40) including a first portion (42) and a second portion (44), the first portion (42) extend from the cursor body (16) and the second portion (44) extends from the first portion (42) and the second portion terminates at a distal end (46); and an isolator (18), the isolator (18) including a first side wall (22) spaced from a second side wall (24), the first side wall (22) being coupled to the second side wall (24) via a living hinge (30), wherein the living hinge (30) is supported by the first portion (42) and the second portion (44) restricts movement of the first side wall (22) when the isolator (18) is secured to the cursor body (16).

### CROSS REFERENCE TO RELATED APPLICATIONS

This application claims the benefit of the following Chinese Patent Applications application No. 202311497872.9 filed on Nov. 10, 2023 and application No. 202323050862.9 filed on Nov. 10, 2023, the entire contents each of which are incorporated herein by reference thereto.

### BACKGROUND

Exemplary embodiments of the present disclosure pertain to the art of vehicle windows and in particular frameless window systems.

Frameless window systems are adjusted for glass sealing in the Y direction.

As such, it is desirable to provide a cursor assembly that can be adjusted when a window is installed into the cursor assembly.

### BRIEF DESCRIPTION

Disclosed is an adjustable cursor assembly for a frameless window of a vehicle door, including: a cursor body, the cursor body having a hook portion, the hook portion including a first portion and a second portion, the first portion extend from the cursor body and the second portion extends from the first portion and the second portion terminates at a distal end; and an isolator, the isolator including a first side wall spaced from a second side wall, the first side wall being coupled to the second side wall via a living hinge, wherein the living hinge is supported by the first portion and the second portion restricts movement of the first side wall when the isolator is secured to the cursor body.

In addition to one or more of the features described above, or as an alternative to any of the foregoing embodiments, wherein the second portion is located within an area surrounded by a peripheral wall, when the isolator is secured to the cursor body, the area being located on the first side wall.

In addition to one or more of the features described above, or as an alternative to any of the foregoing embodiments, further including a clamping plate secured to the first side wall.

In addition to one or more of the features described above, or as an alternative to any of the foregoing embodiments, the cursor body is formed from metal and the isolator is formed from plastic.

In addition to one or more of the features described above, or as an alternative to any of the foregoing embodiments, the first side wall and the second side wall of the isolator define a cavity into which a portion of the window is received when the window is secured to the adjustable cursor assembly.

In addition to one or more of the features described above, or as an alternative to any of the foregoing embodiments, the second side wall has a securement tab configured to be received within an opening of the cursor body.

In addition to one or more of the features described above, or as an alternative to any of the foregoing embodiments, the securement tab has an elongated portion secured to the second side wall via a connecting portion such that the elongated portion is spaced from the second side wall and the opening is “T” shaped having a horizontal portion and a vertical portion and the elongated portion is configured to pass through the horizontal portion but not the vertical portion.

In addition to one or more of the features described above, or as an alternative to any of the foregoing embodiments, further including a clamping plate secured to the first side wall, wherein the first side wall has at least one hook that retains a first portion of the clamping plate and a second portion of the clamping plate is retained by a portion of a tab member of the first side wall.

In addition to one or more of the features described above, or as an alternative to any of the foregoing embodiments, the at least one hook has an angled surface such that an interference fit is made between the clamping plate and the first side wall.

In addition to one or more of the features described above, or as an alternative to any of the foregoing embodiments, the cursor body has two pairs of features that protrude from a surface of the cursor body proximate to the vertical portion of the opening and the two pairs of features are each separated from each other to define a channel, each pair of features of the two pairs of features includes an upper feature and a lower feature, the upper feature having a surface facing the channel, the surface providing a stop in order to limit movement of the elongated portion towards the horizontal portion of the opening.

In addition to one or more of the features described above, or as an alternative to any of the foregoing embodiments, the lower feature has an inclined surface proximate to channel in order to assist with movement of the elongated portion into the channel.

In addition to one or more of the features described above, or as an alternative to any of the foregoing embodiments, a surface of the lower feature makes frictional contact with elongated portion of the securement tab.

In addition to one or more of the features described above, or as an alternative to any of the foregoing embodiments, a slider is located in the cursor body of the adjustable cursor assembly is configured to slidably engage a rail of a window regulator.

In addition to one or more of the features described above, or as an alternative to any of the foregoing embodiments, the area has at least two features protruding from a surface of the first side wall, the at least two features provide a surface that makes frictional contact with the second portion of hook member.

In addition to one or more of the features described above, or as an alternative to any of the foregoing embodiments, the first side wall has a feature protruding from a surface of the first side wall, the feature providing a surface that makes frictional contact with the second portion of hook member.

In addition to one or more of the features described above, or as an alternative to any of the foregoing embodiments, the isolator also includes an inclined guiding feature that provides a surface for guiding a portion of the window into the cavity, the inclined guiding feature having an edge that engages an edge of an opening in the portion of the window such that as the window is adjusted, the isolator will move together with the window.

Also disclosed is a door module, comprising: a window regulator secured to the door module, the window regulator including at least one guide rail secured to the door module; and an adjustable cursor assembly secured to the at least one guide rail, the adjustable cursor assembly including: a cursor body, the cursor body having a hook portion, the hook portion including a first portion and a second portion, the first portion extend from the cursor body and the second portion extends from the first portion and the second portion terminates at a distal end; and an isolator, the isolator including a first side wall spaced from a second side wall, the first side wall being coupled to the second side wall via a living hinge, wherein the living hinge is supported by the first portion and the second portion restricts movement of the first side wall when the isolator is secured to the cursor body.

Also disclosed is a cursor assembly for a frameless window of a vehicle door, including: a cursor body, the cursor body having a hook portion, the hook portion including a first portion and a second portion, the first portion extend from the cursor body and the second portion extends from the first portion and the second portion terminates at a distal end; and an isolator, the isolator including a first side wall spaced from a second side wall, the first side wall being coupled to the second side wall via a living hinge, wherein the living hinge is supported by the first portion and the second portion restricts movement of the first side wall when the isolator is secured to the cursor body.

### BRIEF DESCRIPTION OF THE DRAWINGS

The following descriptions should not be considered limiting in any way. With reference to the accompanying drawings, like elements are numbered alike:

FIG. 1 is a partial view of a vehicle having a window regulator with an adjustable cursor assembly in accordance with the present disclosure;

FIG. 1A is a partial perspective view of a vehicle door and window with an adjustable cursor assembly in accordance with the present disclosure;

FIG. 2A is a perspective view of a first side of the adjustable cursor assembly in accordance with an embodiment of the present disclosure;

FIG. 2B is a perspective view of a second side of the adjustable cursor assembly illustrated in FIG. 2A;

FIG. 2C is an end view of the adjustable cursor assembly in accordance with an embodiment of the present disclosure;

FIG. 3 is an exploded view of the adjustable cursor assembly in accordance with the present disclosure;

FIG. 4A is a perspective view of a first side of an isolator of the adjustable cursor assembly in accordance with an embodiment of the present disclosure;

FIG. 4B is a perspective view of a second side of the isolator illustrated in FIG. 4A;

FIG. 4C is an end view of the isolator illustrated in FIGS. 4A and 4B;

FIG. 4D is a side view of the first side of the isolator illustrated in FIGS. 4A and 4B;

FIG. 4E is a side view of the second side of the isolator illustrated in FIGS. 4A and 4B;

FIG. 4F is a perspective side view of the isolator illustrated in FIGS. 4A and 4B;

FIG. 4G illustrates a portion of the glass of a window received in the isolator illustrated in at least FIGS. 4A-4F;

FIGS. 5A and 5B are perspective views of a cursor body of the adjustable cursor assembly in accordance with the present disclosure;

FIG. 6 is a perspective view of the cursor body with a slider inserted therein;

FIG. 7A is a perspective view of the slider illustrated in FIG. 6;

FIG. 7B is a side view of the slider illustrated in FIG. 6; and

FIG. 7C is a cross sectional view of the slider along lines 7C-7C in FIG. 7B;

FIGS. 8-14 illustrate portions of the cursor body and isolator assembled together; and

FIG. 15 is a perspective view of a cursor assembly in accordance with an alternative embodiment of the present application.

### DETAILED DESCRIPTION

A detailed description of one or more embodiments of the disclosed apparatus and method are presented herein by way of exemplification and not limitation with reference to the Figures.

The present disclosure is directed to an adjustable cursor assembly for use with either a front door assembly or a rear door assembly of a vehicle. The adjustable cursor assembly having the following elements: a cursor body with a slider that is configured to slide along a rail; an isolator; and a clamping plate.

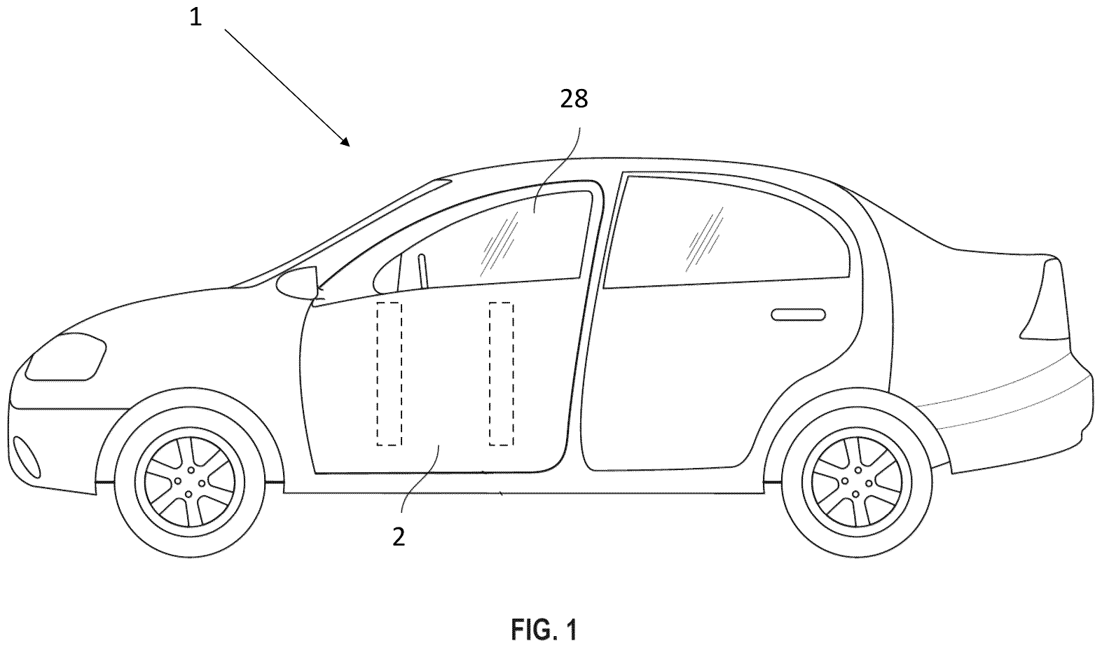

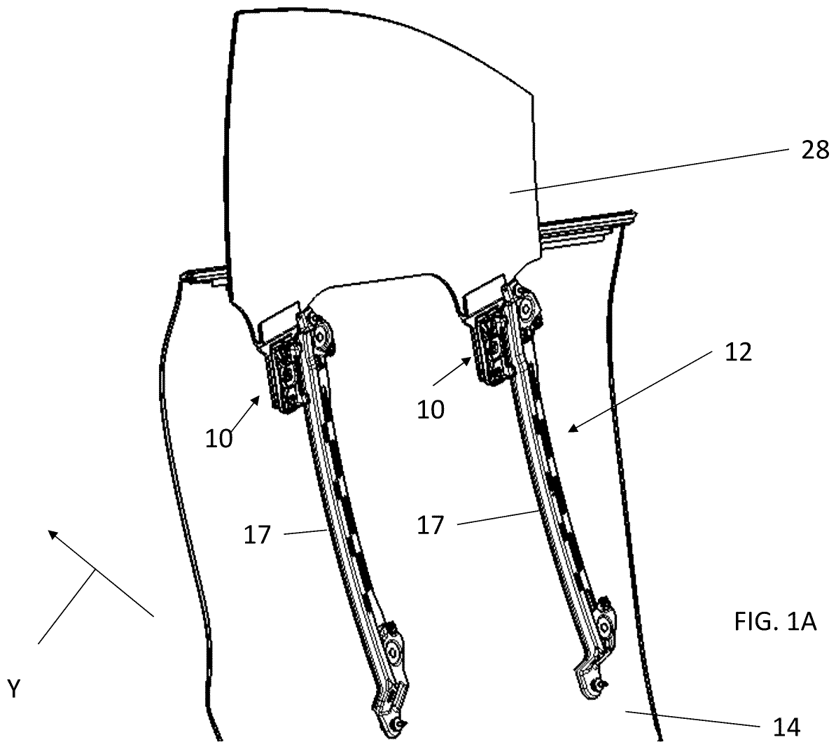

Referring now to the FIGS. and in particular the FIGS. 1 and 1A, an adjustable cursor assembly 10 for use with a window regulator 12 of a vehicle door module 14 in accordance with various embodiments of the present disclosure is illustrated. FIG. 1 is a partial side view of a vehicle 1 having at least one door 2 with a window 14 that is configured to be raised and lowered by the window regulator 12 disposed within door panels (e.g., exterior and interior) of the door 2. Although only one door 2 and window 28 is illustrated with a window regulator 12 it is contemplated that the adjustable cursor assembly 10 of the present disclosure can be used in a vehicle having numerous doors and associated windows. As such, one or more other windows of the vehicle 1 may also be operated by a window regulator 12 with an adjustable cursor assembly 10 according to the present disclosure. In one embodiment, the an adjustable cursor assembly 10 is configured for raising and lowering a window with a frameless vehicle door.

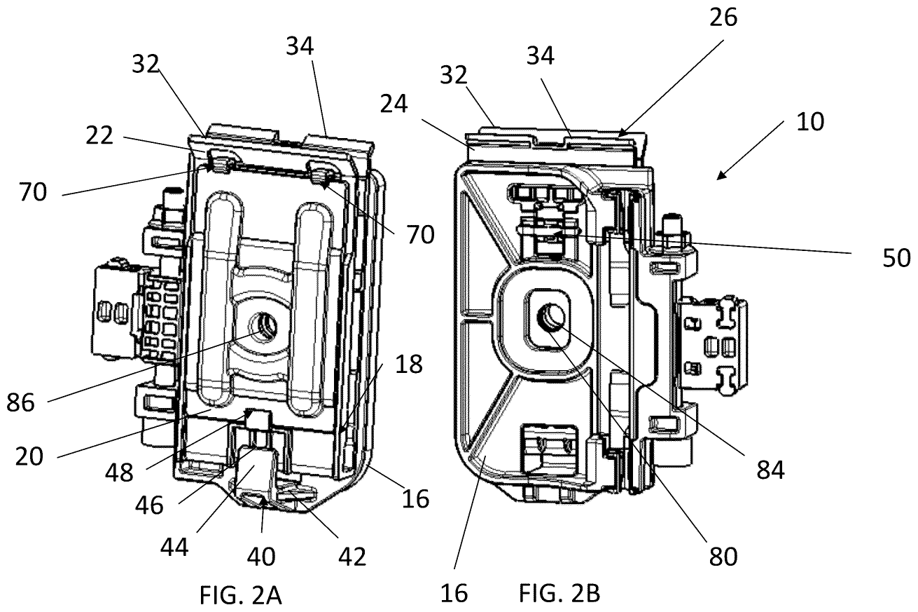

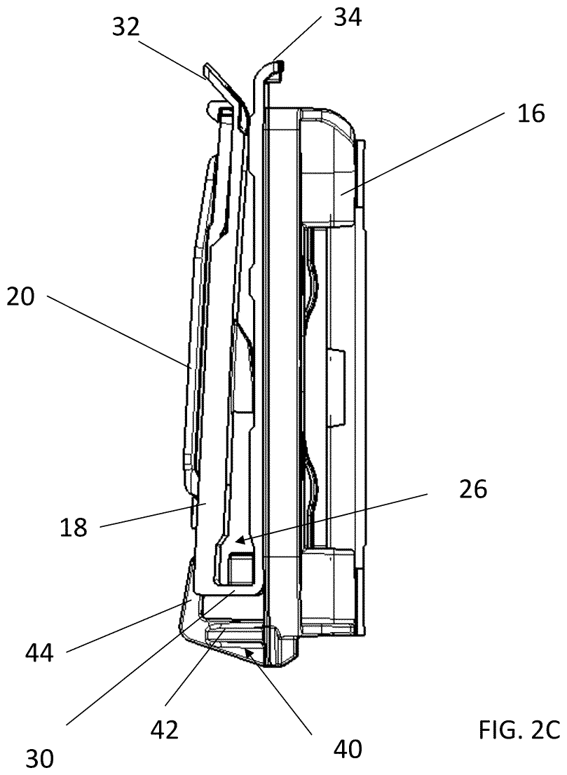

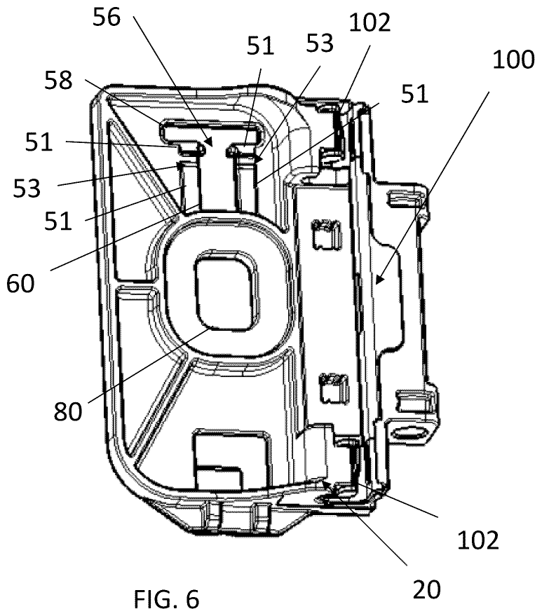

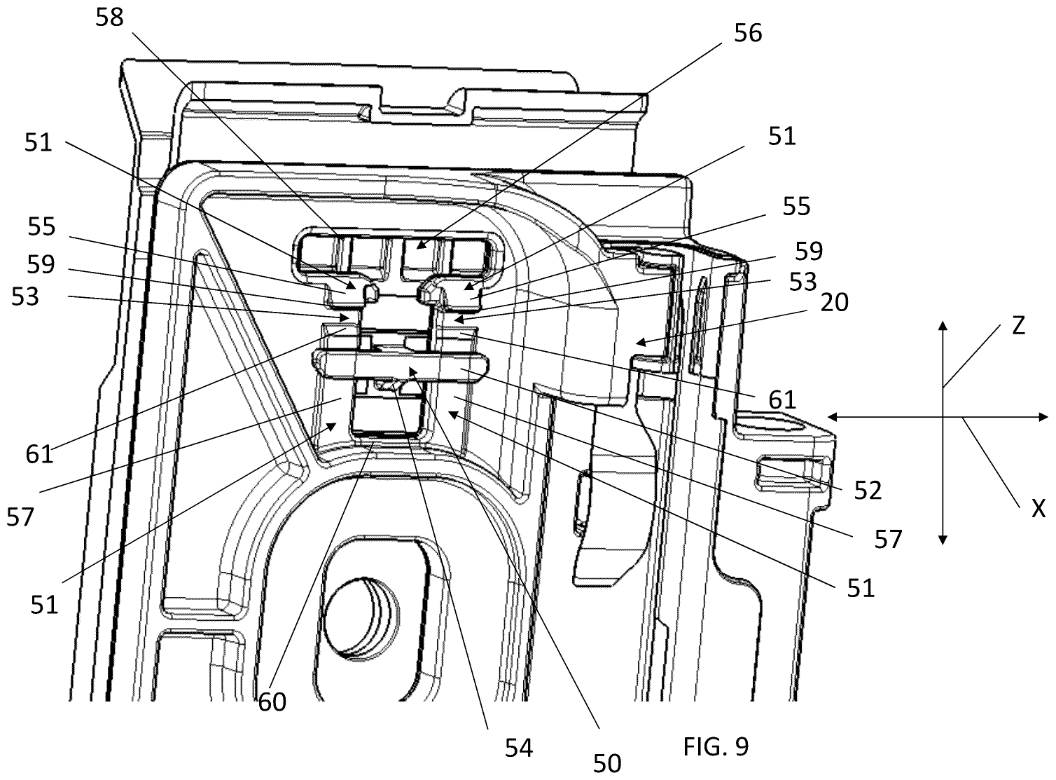

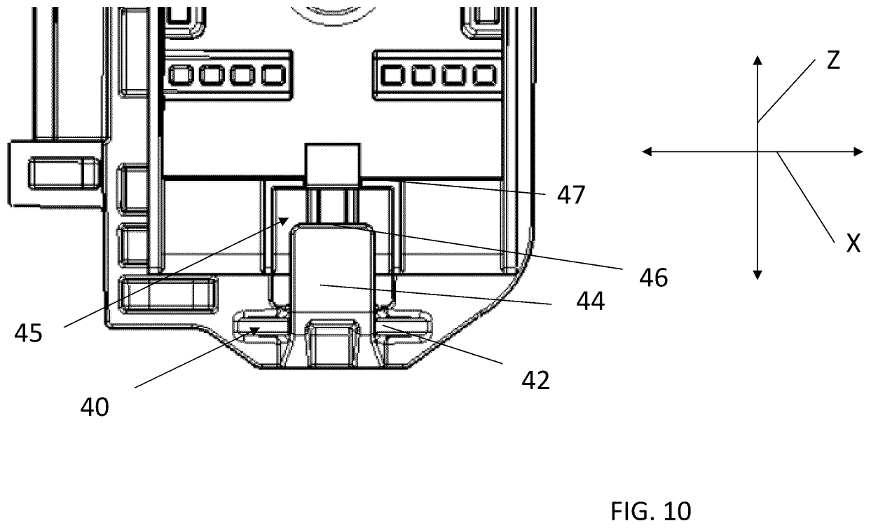

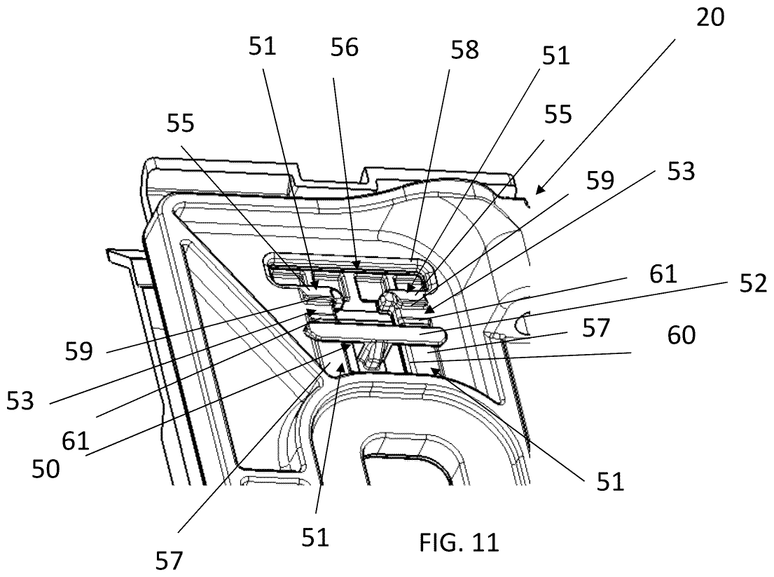

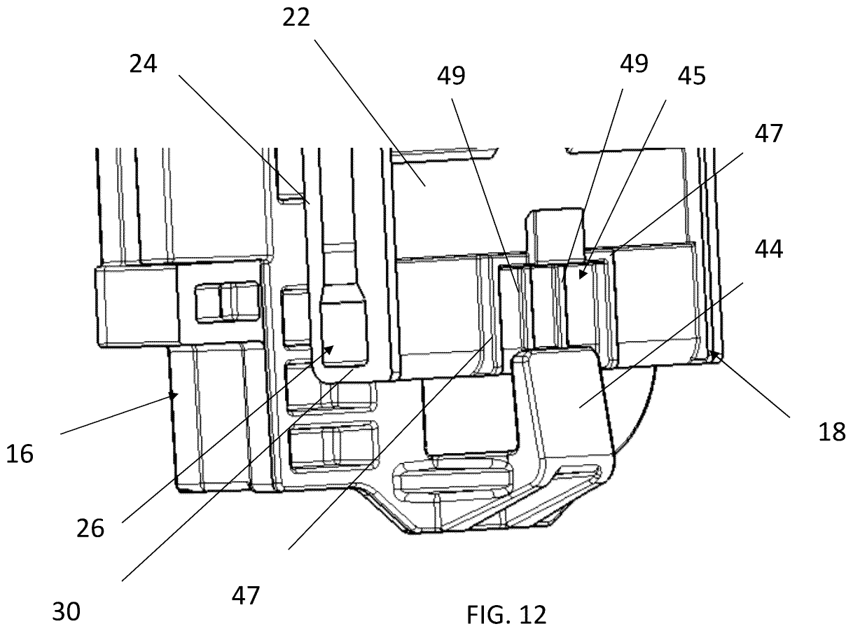

Referring now to at least FIGS. 2A-14, the adjustable cursor assembly 10 and its components and features are illustrated.

FIG. 2A is a perspective view of a first side of the adjustable cursor assembly 10 in accordance with an embodiment of the present disclosure and FIG. 2B is a perspective view of a second side of the adjustable cursor assembly 10, the second side being opposite to the first side. FIG. 2C is an end view of the adjustable cursor assembly 10.

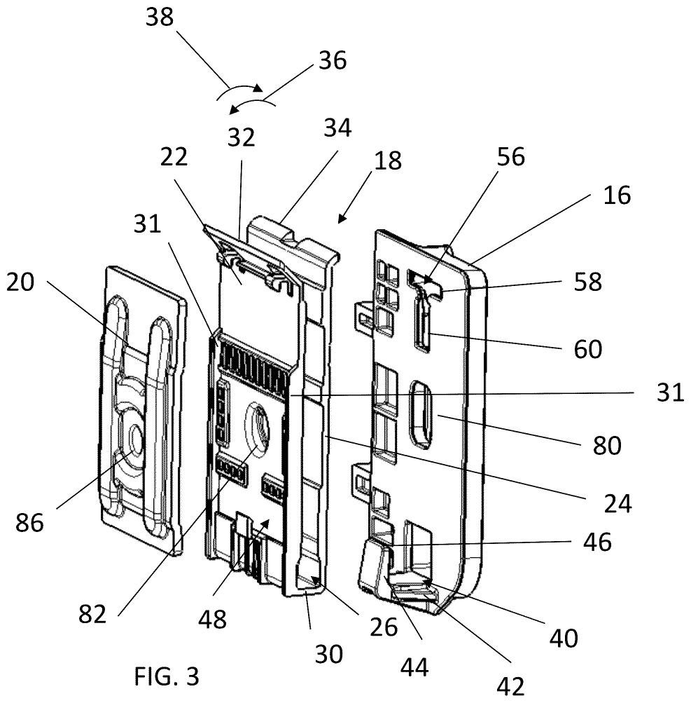

FIG. 3 is an exploded view of the adjustable cursor assembly 10 in accordance with the present disclosure. The adjustable cursor assembly 10 includes at least three separate components, a cursor body 16; an isolator 18; and a clamping plate 20. In one non-limiting embodiment, the cursor body 16 is formed from metal such as aluminum or zinc, and the isolator 18 is formed from plastic. The clamping plate 20 is also formed from metal which may be different or the same as the material used for the cursor body 16.

The isolator 18 includes a pair of opposing side walls 22 and 24 which are configured to define a cavity 26 into which a portion of a window 28 is received when secured to the adjustable cursor assembly 10. The pair of opposing side walls 22 and 24 may be referred to as a first side wall 22 and a second side wall 24. The first side wall 22 is secured to the second side wall 24 through a living hinge 30. As used herein, living hinge 30 refers to a portion of the isolator 18 that connects the first side wall 22 and the second side wall 24 such that the first side wall 22 can rotate with respect to the second side wall 24.

A top portion 32 of the first side wall 22 is spaced from a top portion 34 of the second side wall 24. As such, the top portion 32 of the first side wall 22 is not connected to the top portion 34 of the second side wall 24 while bottom portions of the first side wall 22 and the second side wall 24 are connected to each other via the living hinge 30. Due to this configuration and the living hinge 30, the top portion 32 of the first side wall 22 can move in the direction of arrows 36 and 38 with respect to the top portion 34 of the second side wall 24. While this may be advantageous for adjustment of the window 28 when it is secured to the cursor body 16, excessive movement in the direction of arrow 36 may be undesirable especially when the adjustable cursor assembly 10 has not been secured to the window 28 as movement of the top portion 32 of the first side wall 22 in the direction of arrow 36 may not be restricted and this prevents shipping concerns when the cursor assembly 10 is sent to an original equipment manufacturer who installs the window 28 to the adjustable cursor assembly 10.

In order to prevent undesired movement or limit movement of the top portion 32 of the first side wall 22 in the direction of arrow 36, the cursor body 16 has a hook portion 40. In one embodiment, the hook portion 40 may be integrally formed with the cursor body 16 such that they are a single unitary component alternatively, the hook portion 40 may be separately secured to the cursor body 16.

As illustrated in at least FIGS. 2A, 2C, 3, 5B, 8 and 10, the hook portion 40 has a first portion 42 that extends from the cursor body 16 in a generally horizontal or first direction and a second portion 44 that extends from the first portion in a generally vertical or second direction. While horizontal and vertical directions are mentioned for portions 42 and 44 it is understood that the first portion 42 and the second portion 44 need not be horizontal and vertical with respect to the cursor body 16 as long as the desired functions are achieved. The second portion 44 terminating at a distal end 46. The second portion being received within an area 45 that is defined by a peripheral wall 47, the area 45 being slightly larger than second portion 44 to allow adjustment of the isolator 18 in the X and Z directions. The second portion 44 contact the first side wall and limits movement of the first side wall 22 in the direction of arrow 36 when the isolator 18 is secured to the cursor body 16. Also shown is a tab member 48 that projects from the first side wall 22. The tab member 48 cooperating with the clamping plate 20 in order to secure the clamping plate 20 to the isolator 18.

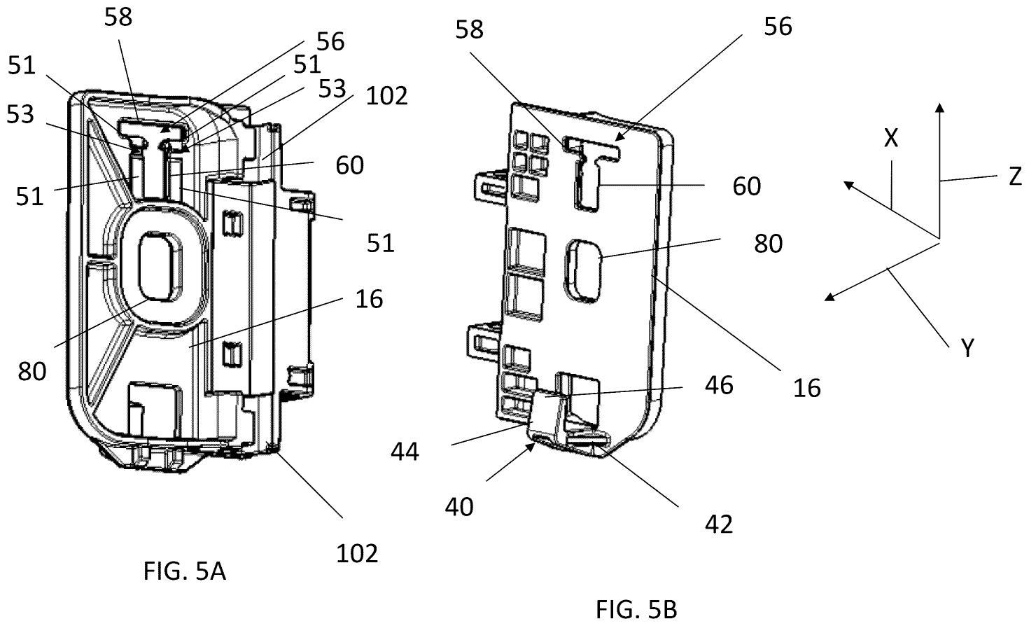

In addition, the first portion 42 of the hook portion 40 contacts the living hinge 30 to provide support in the Z direction. The Z direction being illustrated in at least FIG. 5.

Referring now to at least FIGS. 2B-11, the second side wall 24 has a securement tab 50. In one embodiment, the securement tab 50 is integrally formed with the second side wall 24 such that they are a single unitary component or alternatively the securement tab 50 may be separately secured to the second side wall 24. The securement tab 50 has an elongated portion 52 secured to the second side wall via a connecting portion 54 such that the elongated portion is spaced from the second side wall 24. The elongated portion 52 is configured to be received in “T” shaped opening 56 of the cursor body 16 when the isolator 18 is secured to the cursor body 16. The “T” shaped opening 56 of the cursor body 16 has a horizontal portion 58 and a vertical portion 60. The horizontal portion 58 allows for insertion of the elongated portion 52 therethrough and thereafter, the connecting portion 54 slides within the vertical portion 60 such that the elongated portion 52 is located in a position where it can no longer pass through the “T” shaped opening 56 as the elongated portion 52 is larger than the vertical portion 60 and it is no longer aligned with the horizontal portion 58. In other words, the elongated portion 52 is configured to pass through the horizontal portion 58 but not the vertical portion 60. As such, the securement tab 50 and the “T” shaped opening 56 allows for a quick and easy securement of the second side wall 24 to the cursor body 16.

At the same time, the hook portion 40 of the cursor body 16 also helps to secure the isolator 18 to the cursor body 16. When the isolator 18 is secured to the cursor body by for example securement tab 50, the first portion 42 of the hook portion 40 contacts the living hinge 30 of the isolator 18 and the second portion 44 of the hook portion 40 contacts the first side wall in order to prevent undesired movement of the first side wall 22.

In order to secure the clamping plate 20 to the first side wall 22, the first side wall has a pair of hooks 70 that retains a first or top portion of the clamping plate 20 while a second or bottom portion of the clamping plate 20 is retained by a hook portion 72 of the tab member 48. The pair of hooks 70 may have an angled surface 74 such that an interference fit is made between the clamping plate 20 and the first side wall 22. The angled surface 74 allowing the top portion of the clamping plate 20 to slide past hooks 70 and thereafter retained therein. Although a pair of hooks 70 are illustrated, a single hook or multiple hooks 70 may be employed.

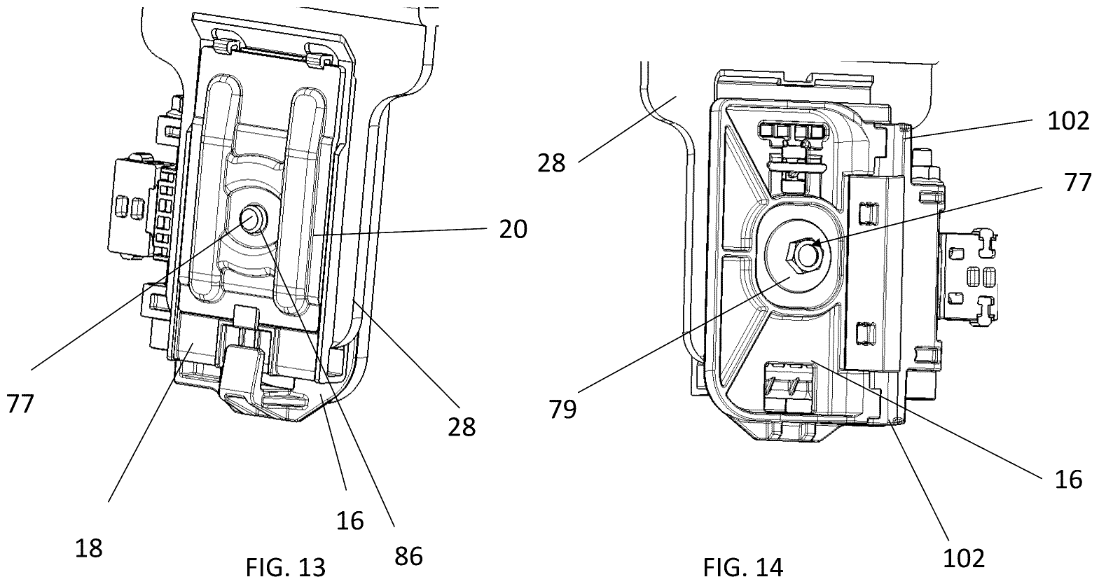

The cursor body 16, the first side wall 22, the second side wall 24 and the clamping plate 20 each have an opening 80, 82, 84 and 86 respectively, that are aligned with each other and an opening (not shown) of the window 28 such that a clamp screw or bolts can secure the window 28 to the cursor assembly 10 at the original equipment manufacturer (OEM). In one non limiting embodiment and as illustrated in at least FIGS. 13 and 14, the opening 86 of the clamping plate 20 may be threaded to engage threads of a clamp screw or bolt 77. In other words, the clamp screw or bolt 77 will have a head portion 79 larger than opening 80 and it will have threads that threadingly engage the threaded opening 86 in order to secure the window 28 to the adjustable cursor assembly 10 after it has passed through openings 80 and 82, an opening in the window 28, opening 84 and then threadingly engaging opening 86.

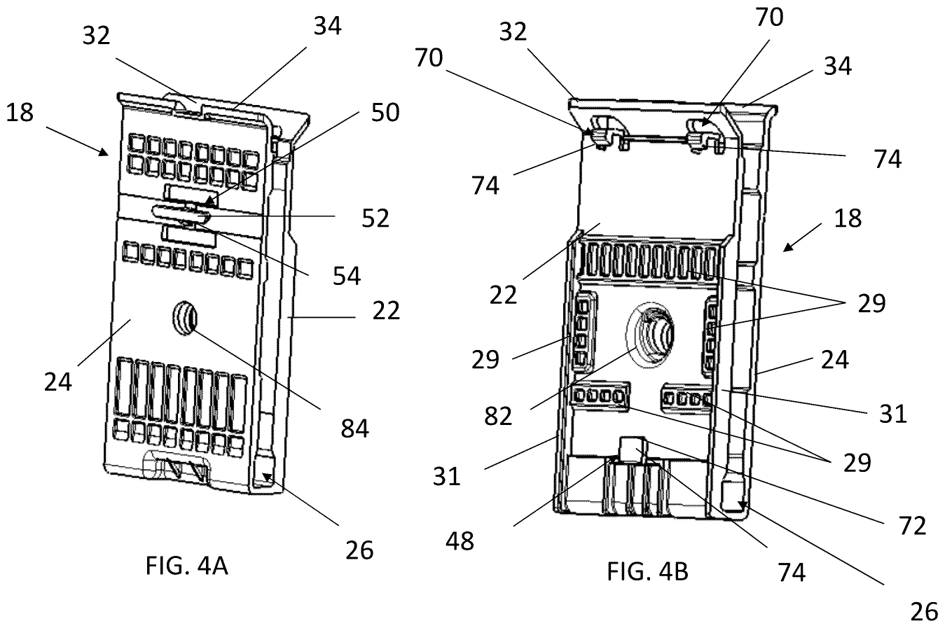

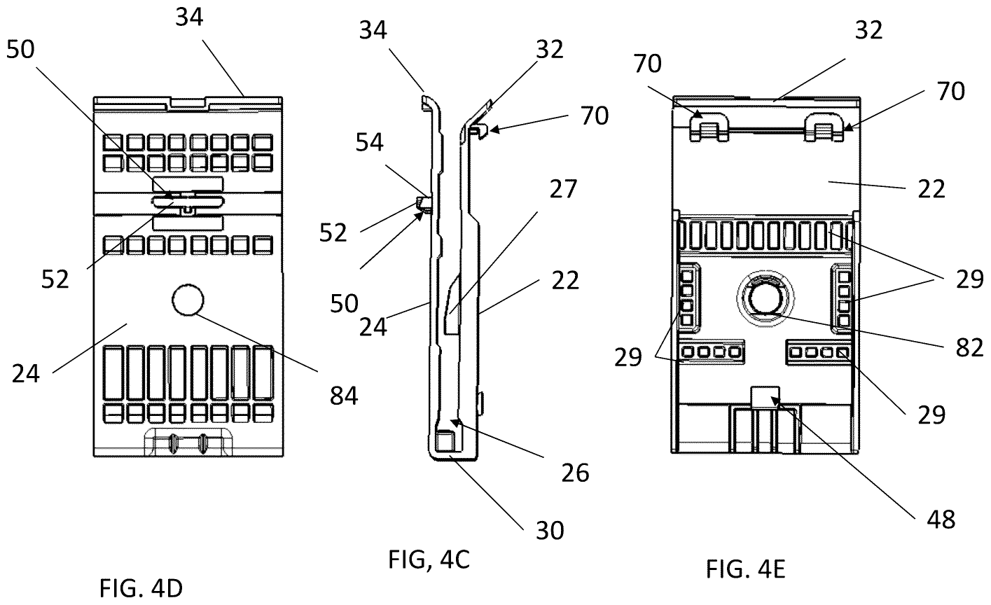

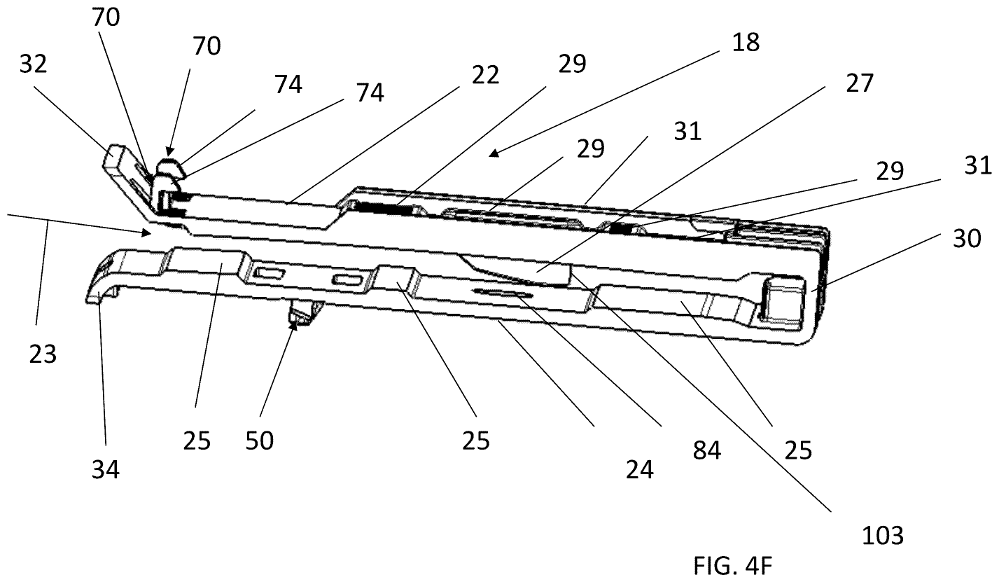

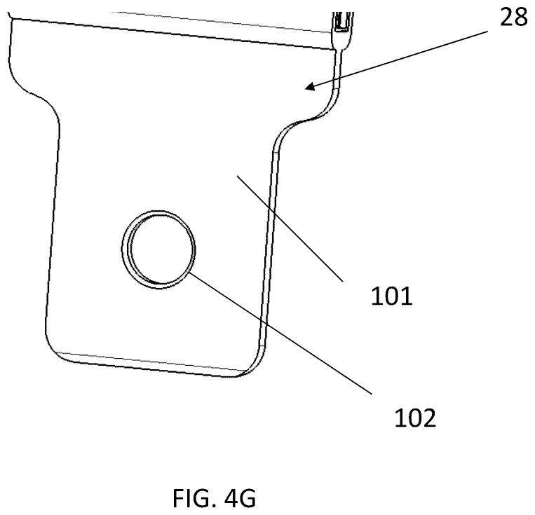

Referring now to at least FIG. 4F, the second side wall 24 has a plurality of raised features 25 that support the glass of the window 28 when it is secured to the adjustable cursor assembly 10 to avoid breakage of the glass. The first side wall 22 of the isolator 18 also includes an inclined guiding feature 27 that provides a surface for guiding a portion of the glass of the window 28 into the cavity 26 in the direction of arrow 23. As a portion 101 of the glass (see at least FIG. 4G) of the window 28 is inserted into the cavity 26 the inclined guiding feature 27 will be received within an opening 102 in the portion 101 of the glass of the window 28 received in the cavity 26 and an edge 103 of the inclined guiding feature 27 will engage an edge of opening 102 such that as the glass of the window 28 is adjusted (such as in X and Z direction), the isolator 18 will move together with glass of the window 28. In addition and on an opposite side of the first side wall 22 a plurality of raised features 29 are provided. The raised features 29 support the clamping plate 20 to avoid glass breakage when securing the window 28 to the adjustable cursor assembly 10. In addition, the first side wall 22 also has a pair of side walls 31 that prevent lateral movement of the clamping plate 20 when it is secured to the first side wall 22.

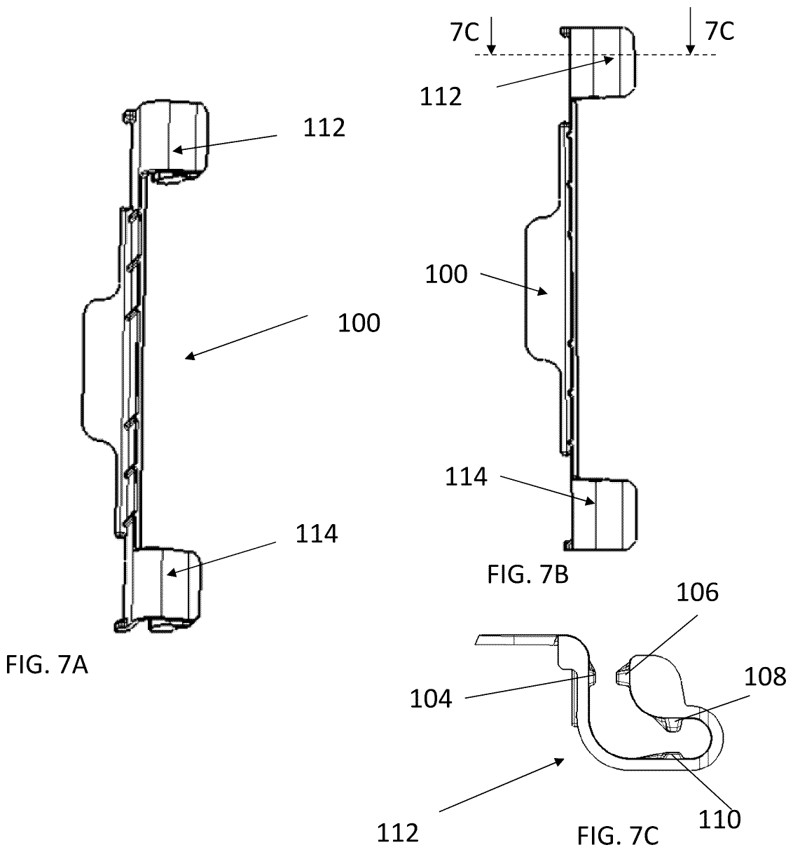

As illustrated in at least FIGS. 1A, 6, 7A, 7B and 7C, the cursor body 16 of the adjustable cursor assembly 10 has a slider 100 secured thereto. The slider 100 is configured to slidably engage a rail 17 of the window regulator 12. The slider 100 is assembled into a slider groove 102 of the cursor body 16. In one non-limiting embodiment, the slider groove 102 of the cursor body 16 is formed from metal while the slider is formed from plastic. The slider 100 contacts the rail 17 at four contact points 104, 106, 108 and 110 in two areas 112 and 114. See for example, the FIG. 7B and the cross sectional view illustrated in FIG. 7C. In FIG. 1, the window regulator 12 is a dual window regulator having a pair of guide rails 17 and a pair of adjustable cursor assemblies 10.

In one non-limiting embodiment, a window regulator 12 for a front door assembly only uses the adjustable cursor assembly 10 for the rear portion of the window 28 while a separate non adjustable cursor assembly 10 is used for the forward portion of the window 28 each being slidably secured to a respective one of the guide rails 17. In another non-limiting embodiment, the window regulator 12 for the front door assembly uses an adjustable cursor assembly 10 for both the rear portion of the window 28 and the forward portion of the window 28 each being slidably secured to a respective one of the guide rails 17. In yet another non-limiting embodiment, the window regulator 12 used with a rear door assembly employs adjustable cursor assembly 10 for both the forward portion of the window 28 and the rear portion of the window 28, each being slidably secured to a respective one of the guide rails 17. Still further and in yet another alternative embodiment, the window regulator for a rear door assembly may use an adjustable cursor assembly 10 for only the rear portion of the window 28 and a separate non adjustable cursor 10 for the forward portion of the window 28 each being slidably secured to a respective one of the guide rails 17. In yet another alternative and in either the front door assembly or the rear door assembly the adjustable cursor assembly 10 may be used for the forward portion of the window 28 and a non adjustable cursor may be used for the rear portion of the window each being slidably secured to a respective one of the guide rails 17.

In one alternative embodiment, the guide rail 17 is a hollow tube or structure formed from a metal such as aluminum, steel, metallic alloys or the hollow tube formed from a plastic material, or a plastic composite material. Still further and in one nonlimiting embodiment, the cursor body portion 16 of the adjustable cursor assembly 10 or a portion thereof or the slider 100 is configured to completely surround a periphery of the guide rail 17. As such, the portion of the cursor body portion 16 of the adjustable cursor assembly 10 surrounding the guide rail 17 will have multiple contact points with the guide rail 17 in order to prevent twisting of the adjustable cursor assembly 10 as it slides up and down the guide rail 17.

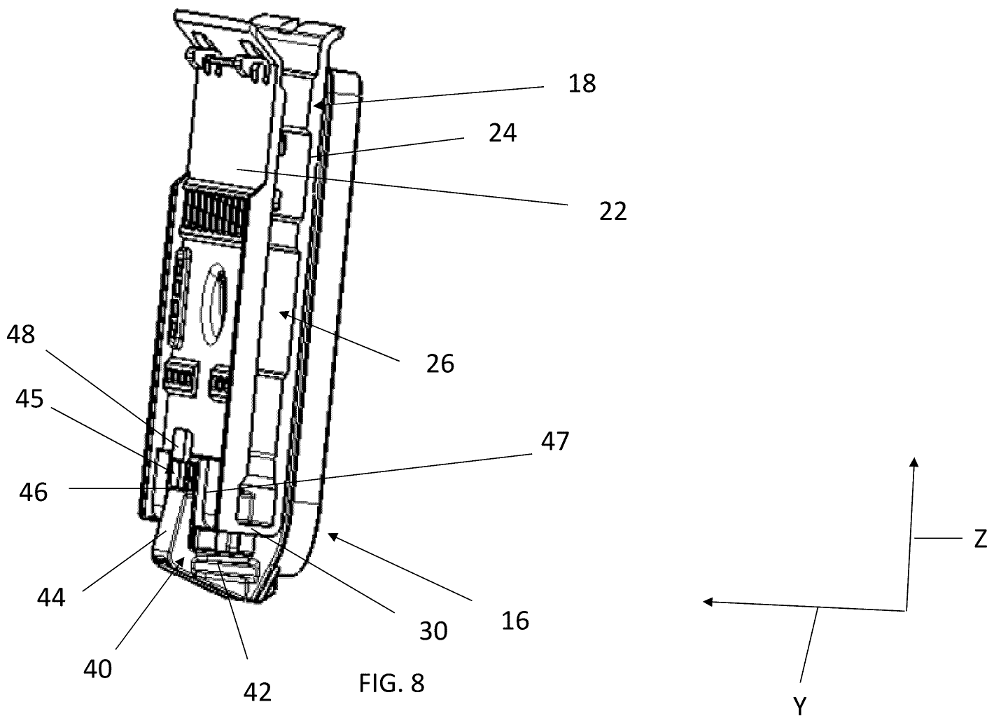

Referring now to at least FIGS. 8-14, portions of the cursor body 16 and isolator 18 assembled together are illustrated. In accordance with the present disclosure, adjustment of the isolator 18 with response to the cursor body 16 in the X and Z directions is provided. As illustrated, the connecting portion 54 of the securement tab 50 is smaller than the vertical portion 60 of the opening 56 in the X direction. In addition, the width of the second portion 44 is smaller than the width of the receiving area 45 in between the peripheral wall 47 in the “X” direction thus lateral movement of the isolator 18 with respect to the cursor body 16 is possible until the connecting portion 54 contacts the edge of the vertical portion 60 of the opening 56 and/or a side of the second portion 44 contacts the peripheral wall 47 when the isolator 18 is secured to the cursor body 16.

In one non-limiting embodiment, this allowable movement for adjustment in the X direction is 2.5 mm in either direction. Of course, movement of greater or less than 2.5 mm is considered to be within the scope of the present disclosure.

Also shown is that adjustment of the isolator 18 with regard to the cursor body 16 in the Z direction is provided. As illustrated, the connecting portion 54 of the securement tab 50 can move in the Z direction before the connecting portion 54 contacts the bottom of the vertical portion 60 of the opening 56 in the Z direction or where the elongated portion 52 makes contact with a surface 59 as discussed below. In addition, the living hinge 30 can move downwardly until it contacts the horizontal portion or first portion 42 of the hook member 40. As such, movement in the “Z” direction is possible for adjustment of the location of the isolator 18 with respect to the cursor body 16. In one non-limiting embodiment, this allowable movement for adjustment in the Z direction is 4.5 mm in either direction. Of course, movement of greater or less than 4.5 mm is considered to be within the scope of the present disclosure.

Still further, the area 45 has at least two features 49 protruding from a surface of the first side wall 22 located within the peripheral wall 47. The at least two features 49 provide a surface that makes contact with the second portion 44 of the hook member 40. In addition, the at least two features 49 extend to the interface with the living hinge 30 which will prevent the isolator 18 from slipping out over the hook member 40 in the Y direction. While at least two features 49 are illustrated it is understood that 1 or more than 2 features 49 may be provided. These surfaces of features 49 will make frictional contact with the portions of the cursor body 16 (e.g., second portion 44 of hook member 50) so that while the cursor body 16 may move with respect to the isolator 18 in a limited range the frictional engagement of the contact surfaces of features 49 and the second portion 44 of hook member 50 will help maintain the location of the isolator 18 with respect to the cursor body 16 until a force is applied that overcomes the frictional forces between the contact surfaces of features 49 and the second portion 44 of hook member 50 in order to relocate the position of the isolator 18 with respect to the cursor body 16.

In addition, the cursor body 16 has two pairs of features 51 that protrude from a surface of the cursor body 16 proximate to the vertical portion 60 of the opening 56. These two pairs of features 51 are each separated from each other to define channels 53 into which the elongated portion 52 is received in order to prevent it from moving upward and into the horizontal portion 58 of the opening 56 once the elongated portion 52 has passed through the horizontal portion 58. Each pair of features 51 includes an upper feature 55 and a lower feature 57. The upper feature 55 having a surface 59 facing the channel 53. Surface 59 providing a stop in order to limit movement of the elongated portion 52 upwardly in the Z direction towards the horizontal portion 58 of the opening 56. As such, this will prevent inadvertent dislodgement of the isolator 18 from the cursor body 16 once the elongated portion 52 of the securement tab 50 has passed through the horizontal portion 58 of the opening 56. The lower feature 57 may also have an inclined surface 61 proximate to channel 53 in order to assist with movement of the elongated portion 52 into the channel 53. In addition, surfaces of the lower features 57 will make frictional contact with elongated portion 52 of the securement tab 50 so that while the cursor body 16 may move with respect to the isolator 18 in a limited range, the frictional engagement of the contact surfaces of lower features 57 and the elongated portion 52 of the securement tab 50 will help maintain the location of the isolator 18 with respect to the cursor body 16 until a force is applied that overcomes the frictional forces between the contact surfaces of lower features 57 and the elongated portion 52 of the securement tab 50 in order to relocate the position of the isolator 18 with respect to the cursor body 16.

As discussed above, it is also understood that movement of the isolator in the X and Z directions with respect to the cursor body 16 may be due to movement of the window 28 when the inclined guiding feature 27 has been received within opening 102 and an edge 103 of the inclined guiding feature 27 engages an edge of opening 102 such that as the glass of the window 28 is adjusted (such as in X and Z direction), the isolator 18 will move together with glass of the window 28.

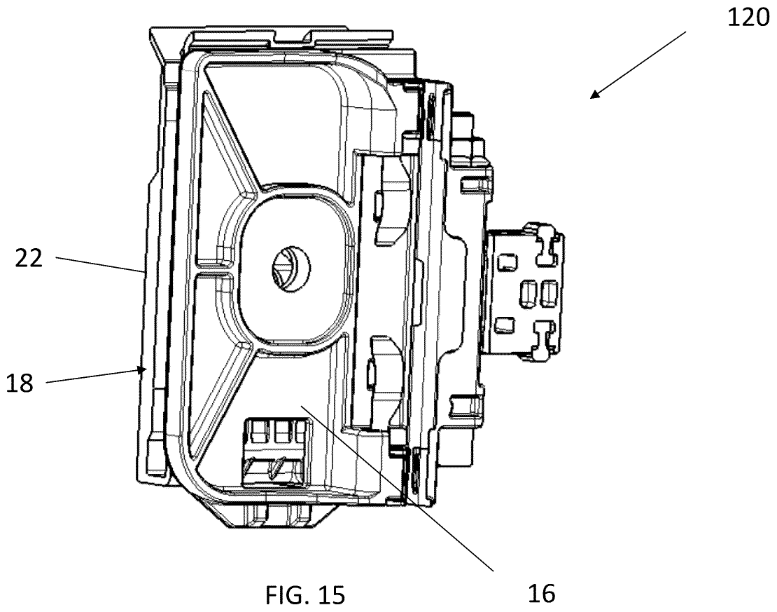

Referring now to FIG. 15, an alternative embodiment of the present application is illustrated. Here a cursor assembly 120 is provided however, the isolator 18 need not be adjusted in the X and Z directions once it is secured to the cursor body 16. As such, the cursor assembly 120 does not have the securement tab 50 that extends from the second side wall 24 and there is no opening 56 in the cursor body 16. Also and in this embodiment, the isolator 18 does not need to be adjusted in the X and Z directions with respect to the second portion 44 and the first portion 42 of the hook portion 40. As such, the cursor assembly 120 illustrated in FIG. 15 has all of the aforementioned features of the adjustable cursor assembly 10 except those necessary for adjustments of the isolator 18 in the X and Z directions with respect to the cursor body 16. In other words, there is no need for the securement tab 50 that extends from the second side wall 24 and there is no opening 56 in the cursor body 16. In addition, and while this embodiment will still have the hook portion 40 with the first portion 42 and the second portion 44 there is no need to allow for the isolator 18 to be moveable in the X and Z directions with respect to the cursor body 16. In addition and in yet another alternative embodiment, the cursor assembly 120 may have a securement tab or feature that extends from the second side wall 24 which is configured to secure the second side wall 24 to the cursor body 16 in a non-adjustable fashion (e.g., in the X and Z directions).

The term “about” is intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An adjustable cursor assembly (10) for a frameless window (28) of a vehicle door, comprising:
a cursor body (16), the cursor body having a hook portion (40), the hook portion (40) including a first portion (42) and a second portion (44), the first portion (42) extend from the cursor body (16) and the second portion (44) extends from the first portion (42) and the second portion terminates at a distal end (46); and
an isolator (18), the isolator (18) including a first side wall (22) spaced from a second side wall (24), the first side wall (22) being coupled to the second side wall (24) via a living hinge (30), wherein the living hinge (30) is supported by the first portion (42) and the second portion (44) restricts movement of the first side wall (22) when the isolator (18) is secured to the cursor body (16).

2. The adjustable cursor assembly (10) as in claim 1, wherein the second portion (44) is located within an area (45) surrounded by a peripheral wall (47), when the isolator (18) is secured to the cursor body (16), the area (45) being located on the first side wall (22).

3. The adjustable cursor assembly (10) as in claim 1 further comprising a clamping plate (20) secured to the first side wall (22).

4. The adjustable cursor assembly (10) as in claim 1, wherein the cursor body (16) is formed from metal and the isolator (18) is formed from plastic.

5. The adjustable cursor assembly (10) as in claim 1, wherein the first side wall (22) and the second side wall (24) of the isolator (18) define a cavity (26) into which a portion (101) of the window (28) is received when the window (28) is secured to the adjustable cursor assembly (10).

6. The adjustable cursor assembly (10) as in claim 1, wherein the second side wall (24) has a securement tab (50) configured to be received within an opening (56) of the cursor body (16).

7. The adjustable cursor assembly (10) as in claim 6, wherein the securement tab (50) has an elongated portion (52) secured to the second side (24) wall via a connecting portion (54) such that the elongated portion (52) is spaced from the second side wall (24) and the opening (56) is “T” shaped having a horizontal portion (58) and a vertical portion (60) and the elongated portion (52) is configured to pass through the horizontal portion (58) but not the vertical portion (60).

8. The adjustable cursor assembly (10) as in claim 2 further comprising a clamping plate (20) secured to the first side wall (22), wherein the first side wall (22) has at least one hook (70) that retains a first portion of the clamping plate (20) and a second portion of the clamping plate (20) is retained by a portion (72) of a tab member (48) of the first side wall (22).

9. The adjustable cursor assembly (10) as in claim 8, wherein the at least one hook (70) has an angled surface (74) such that an interference fit is made between the clamping plate (20) and the first side wall (22).

10. The adjustable cursor assembly (10) as in claim 7, wherein the cursor body (16) has two pairs of features (51) that protrude from a surface of the cursor body (16) proximate to the vertical portion (60) of the opening (56) and the two pairs of features (51) are each separated from each other to define a channel (53), each pair of features (51) of the two pairs of features includes an upper feature (55) and a lower feature (57), the upper feature (55) having a surface (59) facing the channel (53), the surface (59) providing a stop in order to limit movement of the elongated portion (52) towards the horizontal portion (58) of the opening (56).

11. The adjustable cursor assembly (10) as in claim 10, wherein the lower feature (57) has an inclined surface (61) proximate to channel (53) in order to assist with movement of the elongated portion (52) into the channel (53).

12. The adjustable cursor assembly (10) as in claim 10, wherein a surface of the lower feature (57) makes frictional contact with elongated portion (52) of the securement tab (50).

13. The adjustable cursor assembly (10) as in claim 1, wherein a slider (102) located in the cursor body (16) of the adjustable cursor assembly (10) is configured to slidably engage a rail (17) of a window regulator (12).

14. The adjustable cursor assembly (10) as in claim 2, wherein the area (45) has at least two features (49) protruding from a surface of the first side wall (22), the at least two features (49) provide a surface that makes frictional contact with the second portion (44) of hook member (50).

15. The adjustable cursor assembly (10) as in claim 1, wherein the first side wall (22) has a feature (49) protruding from a surface of the first side wall (22), the feature (49) providing a surface that makes frictional contact with the second portion (44) of hook member (50).

16. The adjustable cursor assembly (10) as in claim 5, wherein the isolator (18) also includes an inclined guiding feature (27) that provides a surface for guiding a portion of the window (28) into the cavity (26), the inclined guiding feature (27) having an edge (103) that engages an edge of an opening (102) in the portion of the window such that as the window (28) is adjusted, the isolator (18) will move together with the window (28).

17. A door module (14), comprising:
a window regulator (12) secured to the door module (14), the window regulator including at least one guide rail (17) secured to the door module (14); and
an adjustable cursor assembly (10) secured to the at least one guide rail (17), the adjustable cursor assembly (10) comprising:
a cursor body (16), the cursor body having a hook portion (40), the hook portion (40) including a first portion (42) and a second portion (44), the first portion (42) extend from the cursor body (16) and the second portion (44) extends from the first portion (42) and the second portion terminates at a distal end (46); and
an isolator (18), the isolator (18) including a first side wall (22) spaced from a second side wall (24), the first side wall (22) being coupled to the second side wall (24) via a living hinge (30), wherein the living hinge (30) is supported by the first portion (42) and the second portion (44) restricts movement of the first side wall (22) when the isolator (18) is secured to the cursor body (16).

18. A cursor assembly (10) for a frameless window (28) of a vehicle door, comprising:
a cursor body (16), the cursor body having a hook portion (40), the hook portion (40) including a first portion (42) and a second portion (44), the first portion (42) extend from the cursor body (16) and the second portion (44) extends from the first portion (42) and the second portion terminates at a distal end (46); and
an isolator (18), the isolator (18) including a first side wall (22) spaced from a second side wall (24), the first side wall (22) being coupled to the second side wall (24) via a living hinge (30), wherein the living hinge (30) is supported by the first portion (42) and the second portion (44) restricts movement of the first side wall (22) when the isolator (18) is secured to the cursor body (16).
